(19) United States
(12) Patent Application Publication
(10) Pub. No.: US 2002/0151334 A1
(43) Pub. Date: Oct. 17, 2002

(54) Communications device with call frequency analyzer

(75) Inventor: Ochintya Sharma, Bangalore (IN)

Correspondence Address: MOTOROLA, INC., 1303 EAST ALGONQUIN ROAD, IL01/3RD, SCHAUMBURG, IL, 60196

(73) Assignee: MOTOROLA, INC

(21) Appl. No.: 09/833,161

(22) Filed: Apr. 11, 2001

(51) Int. Cl. H04M 11/00

(52) U.S. Cl. 455/566; 455/405; 455/419

(57) ABSTRACT

A cellular telephone includes a first database memory for storing calling telephone numbers and a first frequency tag associated with each calling telephone number and a second database memory for storing called telephone numbers and a second frequency tag associated with each called telephone number. The first frequency tag indicates the number of times the calling telephone number has called the cell phone and the second frequency tag indicates the number of times the cell phone has called the called telephone number. A controller connected to the first and second database memories accesses the memories and generates respective sorted lists using the first and second frequency tags. A display connected to the controller displays at least a portion of either of the sorted lists and a key allows one of the calling phone numbers in the calling numbers sorted list or one of the called numbers in the called number sorted list to be selected and called. Preferably the sorted lists are updated automatically every time a call is placed and/or received.

### BACKGROUND OF THE INVENTION

1. Field of the Invention

The present invention relates in general to communications devices and more particularly to communications devices that analyze and store the frequency of called and calling numbers.

2. Background of Related Art

Personal communication devices have gained widespread popularity and have dramatically changed the telecommunications industry. Such communications devices include a keypad for entering numbers and text and a small display screen for viewing information. To maintain popularity, these devices have been adding features, such as internal phone books, clocks, calendars, calculators, call related features and games.

Most mobile or cell phone devices include a semi-permanent memory for implementing the phone book feature. The phone book feature is used to store numbers and associated names of parties that are frequently called. While the phone book feature is very handy, it only works if the telephone number of the desired party is stored in the phone book. In some instances the user may not know the number of a party with whom they are frequently in contact or they may not have updated the phone book to include the number.

Accordingly, it would be beneficial to be able to access the phone number of a frequently called party even if that party's number has not been stored in the phone book.

### SUMMARY OF THE INVENTION

In one embodiment, the present invention provides a communications device having a first database memory for storing a plurality of calling telephone numbers and a first frequency tag associated with each calling telephone number. The first frequency tag indicates a number of times the calling telephone number has called the communications device. A controller is connected to the first database memory for accessing the calling telephone numbers and the first frequency tags and creating a sorted list therefrom using the first frequency tags. A display is connected to the controller for displaying at least a portion of the calling numbers sorted list. At least one key is provided for selecting one of the calling phone numbers in the calling numbers sorted list and instructing the controller to call the selected calling number.

In another embodiment, the present invention provides a communications device having a database memory for storing a plurality of called telephone numbers and a frequency tag associated with each called telephone number. The frequency tag indicates a number of times the called telephone number has been called by the communications device. A controller is connected to the database memory for accessing the called telephone numbers and the frequency tags and creating a sorted list therefrom using the frequency tags. A display is connected to the controller for displaying at least a portion of the called numbers sorted list and at least one key is provided for selecting one of the called phone numbers in the called numbers sorted list and instructing the controller to call the selected called number.

In yet another embodiment, the present invention provides a first database memory for storing a plurality of calling telephone numbers and a first frequency tag associated with each calling telephone number and a second database memory for storing a plurality of called telephone numbers and a second frequency tag associated with each called telephone number. The first frequency tag indicates a number of times the calling telephone number has called the communications device and the second frequency tag indicates a number of times the called telephone number has been called by the communications device. A controller is connected to the first and second database memories for accessing the calling telephone numbers and the first frequency tags and creating a first sorted list therefrom using the first frequency tags and for accessing the called telephone numbers and the second frequency tags and creating a second sorted list therefrom using the second frequency tags. A display is connected to the controller for displaying at least a portion of the first sorted list and at least a portion of the second sorted list. At least one key is provided for selecting one of the calling phone numbers in the first sorted list and instructing the controller to call the selected calling number, and for selecting one of the called phone numbers in the second sorted list and instructing the controller to call the selected called number.

The present invention also provides a method of storing information in a communications device, The method includes the steps of providing a first database memory for storing a plurality of calling telephone numbers and a frequency tag associated with each calling telephone number, the frequency tag indicating a number of times the calling telephone number has called the communications device and sorting the calling telephone numbers stored in the first database memory using the frequency tags, thereby creating a calling number sorted list.

The present invention further provides a method of storing information in a communications device, including the steps of providing a database memory for storing a plurality of called telephone numbers and a frequency tag associated with each called telephone number, the frequency tag indicating a number of times the called telephone number has been called by the communications device and sorting the called telephone numbers stored in the database memory using the frequency tags, thereby creating a called number sorted list.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a top plan view of a communications device incorporating the present invention;

FIG. 2 is a block diagram of the circuitry of the communications device of FIG. 1;

FIG. 3 is a table of called numbers generated in accordance with the present invention;

FIG. 4 is a table of calling numbers generated in accordance with the present invention; and

FIG. 5 is a flow chart of a method of updating a called number database in accordance with the present invention.

### DETAILED DESCRIPTION OF PREFERRED EMBODIMENTS

The detailed description set forth below in connection with the appended drawings is intended as a description of the presently preferred embodiments of the invention, and is not intended to represent the only forms in which the present invention may be practiced. The description sets forth sequences of steps for performing the procedures in connection with the illustrated embodiments. It is to be understood, however, that the same or equivalent functions and sequences may be accomplished by different embodiments that are intended to be encompassed within the spirit and scope of the invention. In the drawings, like numerals are used to indicate like elements throughout.

The present invention provides a software implemented feature of a communications device, such as a mobile or cellular telephone, that enables the communications device to generate a histogram analysis of all of the numbers dialed or called by the device and to generate a sorted list of the most frequently called ‘n’ numbers in order of their frequency. The feature further enables the user to view the sorted list and make calls to the numbers in the list. The software feature of the present invention further analyzes the frequency of the numbers calling the communications device, generates a sorted list of calling numbers in order of their frequency, and allows the user to make calls to the numbers in the calling numbers sorted list.

Referring now to FIG. 1, there is shown a cellular telephone 10 capable of incorporating the software feature of the present invention. The telephone 10 is preferably a digital wireless telephone, such as the Motorola Model v8088 manufactured by Motorola Corp. of Schaumburg, Ill. However, as will be apparent to those of ordinary skill in the art, the present invention is applicable to and may be embodied in other communications devices including land line telephones. The telephone 10 has output means including a visual output or display screen 12 and an audio output 14 and input means including a keypad 16 and a microphone 18. The keypad 16 has a plurality of keys such as numeric keys that can be used to enter alphanumeric characters and function keys, such as left and right arrows, menu, OK, etc. The microphone 18 is used to enter instructions and data.

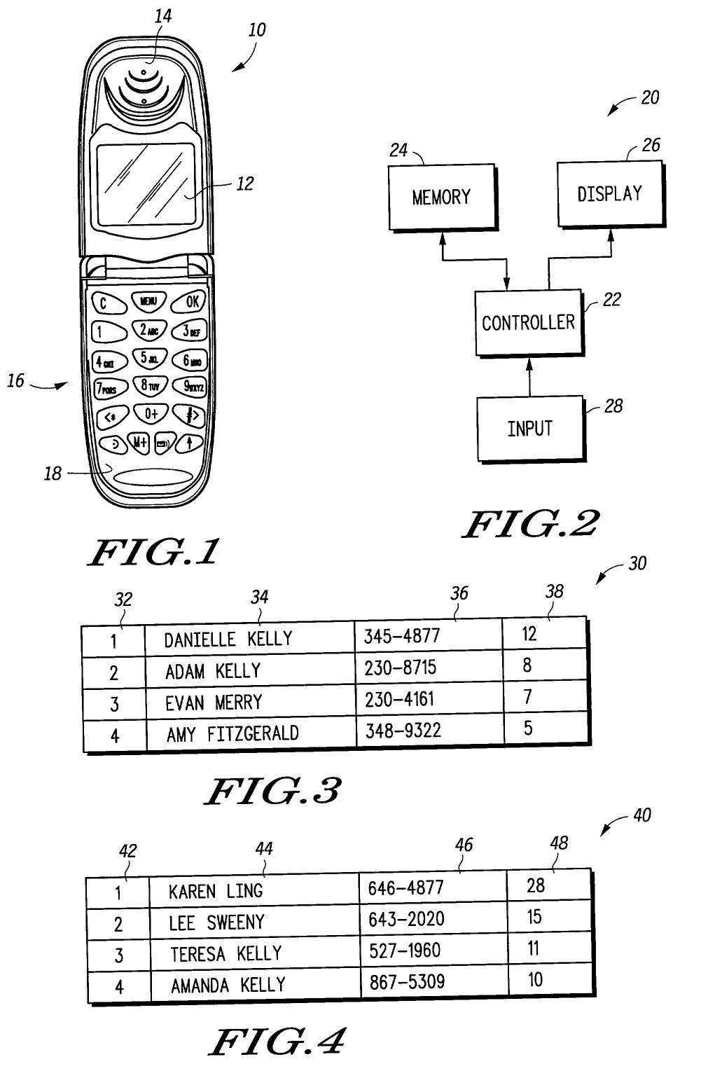

Referring to FIG. 2, a high level block diagram of the circuitry 20 of the telephone 10 is shown. The circuitry 20 includes a controller 22, a memory 24, a display driver 26 and input circuitry 28. The controller 22 includes a processor, such as a digital signal processor and has one or more internal memories (not shown) containing a control program (ROM), set-up data, and a scratch pad area, as is understood by those of skill in the art. The memory 24 is connected to the controller 22 and is used to store data and/or program code. The data stored in the memory 24 can include phone book data, calendar and clock data, stored messages, etc. The memory 24 is preferably a non-volatile random access memory. Functionally, the memory 24 can include the memory space on the SIM (Subscriber Identity Module) card that is used in conjunction with the telephone 10, as is understood by those of skill in the art.

The display controller 26 is connected to the controller 22 and receives and process data from the controller for displaying on the display screen 12. The input circuit 28 is also connected to the controller 26. The input circuit 28 receives input data (commands and data) from the keypad 16 and the microphone 18. The circuitry 20 processes the input data and commands in a manner well understood by those of skill in the art.

With a conventional cell phone, a number is dialed either by entering the number directly into the telephone such as by typing in the number using the keypad or by looking up the number in a phone book stored in the memory 24. Phone book entries can be accessed using such methods as alphabetical lookup, voice tags, or entering the memory location at which the number is stored. Typically, a phone book entry comprises the memory location, an identifier such as the person's name, and a phone number.

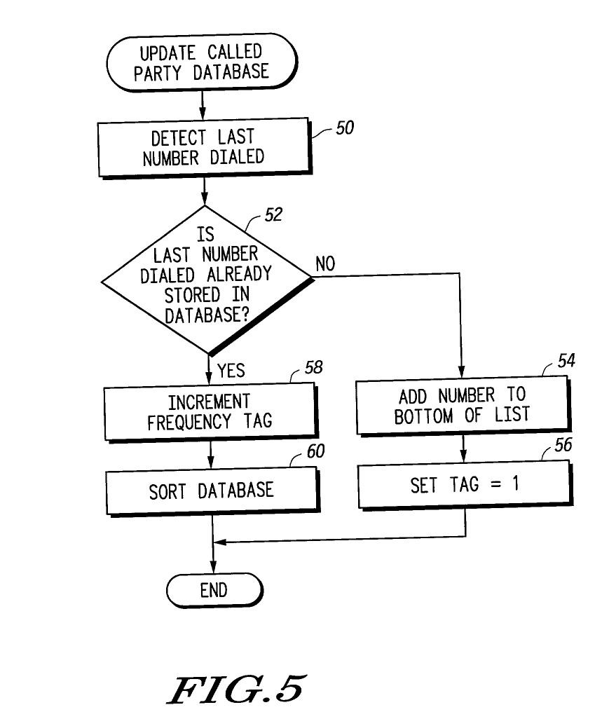

Referring now to FIGS. 3 and 4, according to the present invention, the memory 24 includes a called party database 30 and a calling party database 40. Each of the databases 30, 40 has a plurality of entries, for example ten entries, with each entry having a plurality of fields. Each field in the called party database 30 preferably includes an index number 32, an identifier 34, a phone number 36 and a frequency tag 38. The index number 32 specifies the entry number, which ranges from 1 to ‘n’, where n is an integer. In the presently preferred embodiment, n is set at ten. The identifier 34 can be specified by the user, as explained below, and is used to identify the owner or party at the corresponding phone number 36. In some cases, the identifier 34 may not have a value. The frequency tag 38 indicates the number of times the phone number 36 has been called from the telephone 10. The frequency tag 38 of an associated phone number is incremented each time the phone 10 calls the associated phone number.

Similar to the called party database 30, the calling party database 40 preferably includes an index number 42, an identifier 44, a phone number 46 and a frequency tag 48. The index number 42 specifies the entry number, which ranges from 1 to ‘n’, where n is an integer. In the presently preferred embodiment, n is set at ten. The identifier 44 can be specified by the user, as explained below, and is used to identify the owner or party at the corresponding phone number 46. In some cases, the identifier 44 may not have a value. The frequency tag 48 indicates the number of times the telephone 10 has been called by a telephone having the phone number specified in the phone number field 46. The frequency tag 48 of an associated number is incremented every time a call is received from that telephone.

The databases 30, 40 preferably are updated every time a call is placed to the telephone 10 and placed by the telephone 10, respectively. The databases 30, 40 are displayed by issuing a command to the telephone 10, for example, by manipulating buttons on the keypad 16 or via voice recognition. One of the entries in the displayed database 30, 40 can then be selected, preferably using a key such as an arrow key to scroll through the displayed database 30, 40 and then the phone number at the selected entry can be dialed, preferably with a key stroke, such as by pressing the OK key on the keypad 16.

In the presently preferred embodiment, the databases 30, 40 are built and updated dynamically. Further, it is preferred that the software that builds the databases 30, 40 is able to check the phone book database (not shown) in order to automatically fill in the identifier fields 34, 44 using information in the phone book memory. Of course, some telephone numbers (called and calling) will not be listed in the phone book, so the identifier fields 36, 46 associated with these numbers will be blank. It is also preferred that if the caller identification function is enabled, the software uses the identification information provided to fill in the identifier 44 in the calling party database 40.

After a call is received or a call is placed, the software preferably updates the respective database 30, 40 by updating the frequency tag 38, 48 and performing resorting the database 30, 40. Alternatively, while the tag fields 38, 48 can be updated on a per call basis, the frequency analysis or sorting can be performed only when specified by issuing a command, such as a perform frequency analysis command that is accessible via a menu option.

An efficient sort algorithm is applied to do a histogram analysis of the numbers stored in the database 30, 40. Sorting algorithms, for example bubble sort, heap sort, insertion sort, shell sort and partition exchange sort, capable of performing this analysis are well known. Preferably the sorted list, i.e., the databases 30, 40 are displayed through a user activated menu option or by a key press and, as discussed above, the user may call a selected one of the numbers on the list by scrolling to the number and then issuing a call command.

Referring now to FIG. 5, a flow chart of a sequence of updating or maintaining the called party database 30 is shown. The sequence of steps for maintaining the calling party database 40 is similar and thus will be understood by those of skill in the art without the need for repetition.

First, at step 50, the last number called by the telephone 10 is detected and saved. The number may be saved at the time it is dialed or after the call is completed. Thus, the updating of the database 30 may be performed either while a telephone call is in progress or after the call has been ended.

At step 52, the last number dialed is compared with the numbers stored in the database 30 to determine if the number has already been stored in the database 30. If the number is not found in the database 30, the at step 54, a new entry is created at the end of the database 30 and the frequency tag for the new entry is set at 1 in step 56. Since the number is a new entry and has a frequency tag value of 1, the database 30 does not need to be resorted. However, if the database includes date criteria so that numbers that have not been dialed within a predetermined time period, for example 3 weeks, step 56 may be followed by a sorting step (step 60) in case an older in time entry needs to be removed.

If the number is found in the database in step 52, then at step 58 the frequency tag of the found number is incremented. After the frequency tag of the number has been incremented, the database 30 is sorted at step 60 based on the value of the frequency tags. The sorted database 30 can then be displayed as desired by the user.

The present invention allows the user to call both a frequent caller (one who calls frequently) and a frequently called party (one whom the user calls frequently) without having to access mechanisms like the phone book.

The description of the preferred embodiments of the present invention have been presented for purposes of illustration and description, but are not intended to be exhaustive or to limit the invention to the forms disclosed. It will be appreciated by those skilled in the art that changes could be made to the embodiments described above without departing from the broad inventive concept thereof. For example, a telephone could include only one of the called and calling party databases or both. Further a telephone could tag the phone book entries with one or both of a called party frequency tag and a calling party frequency tag and then sort the phone book according to a user specified option using one of the frequency tags as an alternative to alphabetically sorting the phone book. It is understood, therefore, that this invention is not limited to the particular embodiments disclosed, but covers modifications within the spirit and scope of the present invention as defined by the appended claims.

1. A communications device, comprising:
a first database memory for storing a plurality of calling telephone numbers and a first frequency tag associated with each calling telephone number, the first frequency tag indicating a number of times the associated calling telephone number has called the communications device;
a controller connected to the first database memory for accessing the calling telephone numbers and the first frequency tags and creating a sorted list therefrom using the first frequency tags;
a display connected to the controller for displaying at least a portion of the calling numbers sorted list; and
at least one key for selecting one of the calling phone numbers in the calling numbers sorted list and instructing the controller to call the selected calling number.

2. The communications device of claim 1, further comprising:
a second database memory for storing a plurality of called telephone numbers and a second frequency tag associated with each called telephone number, the second frequency tag indicating a number of times the associated called telephone number has been called by the communications device.

3. The communications device of claim 2, wherein the controller is connected to the second database memory for accessing the called telephone numbers and the second frequency tags and creating a second sorted list therefrom using the second frequency tags, the display is capable of displaying at least a portion of the called numbers sorted list, and the at least one key is capable of selecting one of the called phone numbers in the called numbers sorted list and instructing the controller to call the selected called number.

4. A communications device, comprising:
a database memory for storing a plurality of called telephone numbers and a frequency tag associated with each called telephone number, the frequency tag indicating a number of times the called telephone number has been called by the communications device;
a controller connected to the database memory for accessing the called telephone numbers and the frequency tags and creating a sorted list therefrom using the frequency tags;
a display connected to the controller for displaying at least a portion of the called numbers sorted list; and
at least one key for selecting one of the called phone numbers in the called numbers sorted list and instructing the controller to call the selected called number.

5. A communications device, comprising:
a first database memory for storing a plurality of calling telephone numbers and a first frequency tag associated with each calling telephone number, the first frequency tag indicating a number of times the calling telephone number has called the communications device;
a second database memory for storing a plurality of called telephone numbers and a second frequency tag associated with each called telephone number, the second frequency tag indicating a number of times the called telephone number has been called by the communications device;
a controller connected to the first and second database memories for accessing the calling telephone numbers and the first frequency tags and creating a first sorted list therefrom using the first frequency tags and for accessing the called telephone numbers and the second frequency tags and creating a second sorted list therefrom using the second frequency tags;
a display connected to the controller for displaying at least a portion of the first sorted list and at least a portion of the second sorted list; and
at least one key for selecting one of the calling phone numbers in the first sorted list and instructing the controller to call the selected calling number, and for selecting one of the called phone numbers in the second sorted list and instructing the controller to call the selected called number.

6. A method of storing information in a communications device, comprising the steps of:
providing a first database memory for storing a plurality of calling telephone numbers and a frequency tag associated with each calling telephone number, the frequency tag indicating a number of times the calling telephone number has called the communications device; and
sorting the calling telephone numbers stored in the first database memory using the frequency tags, thereby creating a calling number sorted list.

7. The method of storing information of claim 6, further comprising the step of:
storing the calling number sorted list in a second database memory.

8. The method of storing information of claim 6, further comprising the step of:
storing the calling number sorted list back into the first database memory, thereby providing an updated sorted list.

9. The method of storing information of claim 8, wherein the first database memory is automatically updated and the sorting step is automatically performed every time the communications device is called.

10. A method of storing information in a communications device, comprising the steps of:
providing a database memory for storing a plurality of called telephone numbers and a frequency tag associated with each called telephone number, the frequency tag indicating a number of times the called telephone number has been called by the communications device; and
sorting the called telephone numbers stored in the database memory using the frequency tags, thereby creating a called number sorted list.

11. The method of storing information of claim 10, further comprising the step of:
displaying the called number sorted list on a display screen;
selecting one of the called numbers of the called number sorted list; and
dialing the selected called number.

12. A method of initiating a call from a wireless communications device, comprising the steps of:
providing a database memory for storing a plurality of called telephone numbers and a frequency tag associated with each called telephone number, the frequency tag indicating a number of times the called telephone number has been called by the communications device, wherein the database is sorted based on the frequency tags;
displaying at least a portion of the database on a display screen;
selecting one of the displayed called numbers; and
dialing the selected called number.
